(19) United States
(12) Patent Application Publication
(10) Pub. No.: US 2018/0299020 A1
(43) Pub. Date: Oct. 18, 2018

(54) Temperature Responsive Pressure Relief Filter Vent Device for Storage Drums

(71) Applicants: Mark Shaw, Ponte Vedra Beach, FL (US); Jacque Hahn, Saint Johns, FL (US); Dan Kissel, Rexburg, ID (US); Michael Rivera, Boulder, CO (US)

(72) Inventors: Mark Shaw, Ponte Vedra Beach, FL (US); Jacque Hahn, Saint Johns, FL (US); Dan Kissel, Rexburg, ID (US); Michael Rivera, Boulder, CO (US)

(21) Appl. No.: 15/955,478

(22) Filed: Apr. 17, 2018

Related U.S. Application Data
(60) Provisional application No. 62/486,768, filed on Apr. 18, 2017.

(51) Int. Cl. F16K 17/14

(52) U.S. Cl. CPC F16K 17/14

(57) ABSTRACT

A temperature responsive pressure relief filter vent device for a storage drum having an annular sleeve member composed of a fusible material, such as a polymer or low melt temperature metal. The mating portion of the device is externally threaded and the fusible sleeve member is internally and externally threaded. With this structure, the fusible sleeve is mated with the eternally threaded mating portion and this assembly is then mounted into the threaded opening of a drum, thereby securing the pressure relief device onto the drum. Under elevated temperature conditions, as the temperature of the fusible sleeve approaches or reaches the melting point of the fusible material, the sleeve will soften or melt sufficiently such that pressure buildup within the drum causes the pressure relief device to be expelled from the drum.

This application claims the benefit of U.S. Provisional Patent Application Ser. No. 62/486,768, filed Apr. 18, 2017.

### BACKGROUND OF THE INVENTION

This application relates generally to the field of plugs, valves, vents and/or filters, such as used with storage drums or containers (hereinafter referred to collectively as “drums”), and more particularly relates to such devices that are temperature responsive devices designed to release pressure in emergency situations to avoid catastrophic failure of the drum, i.e., ejection of the drum lid or rupture of the drum wall, and which comprise a venting and filtering mechanism such that internally created gases are gradually released to reduce pressure.

Ejection of the drum lid is designated as a catastrophic failure since in many circumstances the extreme pressure required to eject the drum lid combined, with the sudden release of extreme internal pressure results in the ejection of the drum contents into the ambient as well. This is especially dangerous when the drum contents are hazardous or radioactive materials.

Plugs, valves, vents, filters and similar closure components are well known for use in conjunction with storage drums, such as for example 30- or 55-gallon drums made of metal or polymer. Many of these devices are pressure release or relief devices, such that when a threshold pressure is exceeded inside the drum, the devices provide a means for release of gases from the interior of the drum. Increased pressure may result from internal factors, e.g., the chemical reaction of various materials contained in the drum or radioactive decay, or from external factors, e.g., a fire in the storage area containing the drums. In some circumstances, the dram lid is mounted onto the drum body such that the entire lid will release if internal pressure exceeds a maximum amount.

Some pressure relief devices operate passively, such as filter vents that allow gradual passage of non-hazardous gases such as hydrogen from a drum by diffusion through filter media that precludes passage of hazardous gases. Others operate mechanically in response to a rise in internal pressure, such as a valve maintained in the closed position by a spring until the biasing strength of the spring is exceeded. Others utilize fusible material, i.e., material that melts or softens under elevated temperatures, such as a polymer or low melt temperature metal, and are temperature responsive, such that internal pressure is released when the fusible material blocking a bore or passageway softens or melts to the point that the internal pressure is sufficient to move or flush the fusible material, thereby opening the bore or passageway and allowing gas to escape from the drum prior to catastrophic failure of the drum. The fusible material pressure release means are effective since they address internal chemical reactions or radioactive decay and external fires or excessive ambient temperatures which result in temperature elevation within the drum.

These pressure relief devices, whether activated mechanically or with a fusible material, suffer from a problem in that the diameter of the bore or passageway within the pressure relief device, while sufficiently sized to meet the need for release of small quantities of gases occurring from long-term chemical reactions or decay, is typically too small to allow for rapid release of the large quantity of gases that develop under extreme circumstances, which may occur as a result of internal combustion within the drum or from external fires. In these cases, the pressure build-up within the drum will exceed the relief ability of the pressure relief devices and catastrophic failure of the drum will occur.

To address this, it is known to provide pressure relief devices, which may or may not include a slow pressure buildup release means providing for the escape of gases through bores or passageways in the device, which also include pressure release means responsive to rapid, high temperature elevation within the drum. For example, U.S. Pat. No. 4,325,398 to Green, U.S. Pat. No. 5,240,027 to Vertanen, and U.S. Pat. No. 5,551,470 to Duvall show pressure relief devices that utilize a fusible material which allows a major portion of or the entire pressure relief device to be expelled or blown off from the drum, thereby presenting a large opening for the immediate release of the internal gases. A drawback to each of these known devices is that they possess complex designs to accommodate the fusible material. Since the storage of hazardous or radioactive materials is highly regulated, the complex designs may not meet the acceptable standards as currently written, or may require extensive testing to prove that the complex designs are suitable. The complex designs also result in increased manufacturing and material costs.

It is an object of this invention to provide a temperature responsive pressure relief filter vent device Which incorporates a fusible material such that the pressure relief device is expelled from the drum in response to a rapid elevation in temperature within the drum, thereby creating a relatively large opening such that a sufficiently large quantity of gases may be rapidly released, thereby preventing catastrophic failure of the drum. It is a further object to provide such a device wherein the fusible material is structured to be externally mountable to the operational portion of the filter vent component such that redesign of the internal structure of the filter vent component is not required, the fusible material being a sleeve or collar having external mechanical mating structure to mate with the standard mating structure found in drum lids.

### BRIEF DESCRIPTION THE DRAWINGS

FIG. 1 illustrates a representative embodiment of the temperature responsive pressure relief filter vent device in expanded and partially exposed form as mounted onto a drum.

### SUMMARY OF THE INVENTION

The invention comprises in general a filter vent drum closure device comprising an annular collar or sleeve member composed of a fusible material, such as a polymer or low melt temperature metal, the sleeve member adapted to mate with a standard lid opening or bung hole of a drum lid. In a preferred embodiment, the main body of the drum closure device is externally threaded and the fusible collar member is internally and externally threaded. With this structure, the fusible collar is threadingly mated onto the external threading of the main body of the drum closure device and the drum closure device is then mounted into the threaded opening of a drum lid, thereby securing the device onto the drum. Under elevated temperature conditions, as the temperature of the fusible collar approaches or reaches the melting point of the fusible material, the collar will soften or melt sufficiently such that the pressure buildup within the drum will cause the drum closure device to be expelled from the drum, completely unblocking the lid opening to provide for a controlled pressure release. The material of composition and structural configuration of the annular sleeve is chosen such that the drum closure device will be expelled at an internal drum pressure much below the pressure which would result in catastrophic failure of the drum, either through ejection of the drum lid or rupture.

Alternatively expressed, the invention is a temperature responsive pressure relief filter vent device adapted to seal an internally threaded storage drum lid opening, said device structured to filter and gradually release gases from inside the storage drum, said device comprising a mating portion comprising external threading and a fusible sleeve member, said fusible sleeve member comprising internal threading and external threading, said fusible sleeve sized to receive said mating portion and to mount into the internally threaded drum lid opening, in further embodiments, the device wherein the storage drum has an internal drum pressure X at which catastrophic failure occurs, and wherein the material of composition of said fusible sleeve member is chosen such that in ambient temperature said device is retained within said drum lid opening at internal pressures up to internal drum pressure X, whereas in an elevated temperature said fusible sleeve member softens or melts such that said device is ejected from said drum lid opening at an internal drum pressure less than X; wherein said device is ejected from said drum lid opening prior to the internal drum pressure reaching two-thirds of the internal drum pressure X; wherein said fusible sleeve member is composed of a polymer; wherein said external threads of said mating portion and said external threads of said fusible sleeve member are both righthanded or both lefthanded; and/or wherein the pitch of said external threads of said mating portion and said internal threads of said fusible sleeve member are different from the pitch of said external threads of said fusible sleeve member.

Alternatively, the invention is a method of preventing catastrophic failure in a storage drum, said drum having a threaded lid opening, comprising the steps of: providing a temperature responsive pressure relief filter vent device adapted to seal an internally threaded storage drum lid opening, said device structured to filter and gradually release gases from inside the storage drum, said device comprising a mating portion comprising external threading and a fusible sleeve member, said fusible sleeve member comprising internal threading and external threading, said fusible sleeve sized to receive said mating portion and to mount into the internally threaded drum lid opening; mounting said fusible sleeve member onto said mating portion; and screwing said fusible sleeve member into the threaded lid opening of the drum. Furthermore, this method further comprising the step of: determining the internal drum pressure X at which catastrophic failure of the drum occurs; and choosing the material of composition of said fusible sleeve member such that in ambient temperature said device is retained within the drum lid opening at internal pressures up to internal drum pressure X, whereas in an elevated temperature said fusible sleeve member softens or melts such that said device is ejected from said drum lid opening at an internal drum pressure less than X; and/or wherein said step of choosing the material of composition of said fusible sleeve member such that in ambient temperature said device is retained within the drum lid opening at internal pressures up to internal drum pressure X, whereas in an elevated temperature said fusible sleeve member softens or melts such that said device is ejected from said drum lid opening at an internal drum pressure less than X, comprises choosing the material composition such that said device is ejected at an internal pressure less than two-thirds of the internal pressure X.

### DETAILED DESCRIPTION OF THE INVENTION

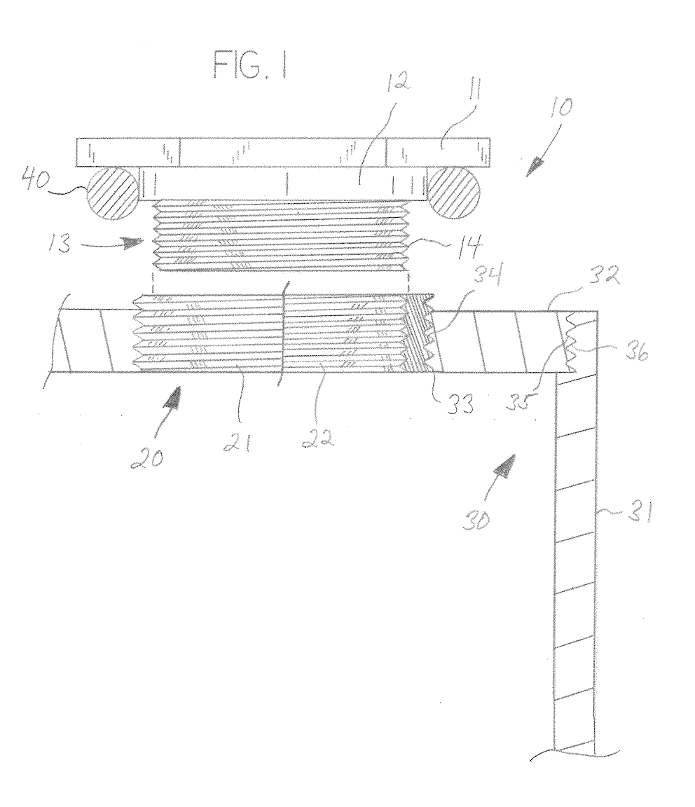

In general, the invention is a temperature responsive pressure relief filter vent device 10 adapted to seal a drum 30, the device 10 having an annular collar or sleeve member 20 composed of a fusible material, such as a polymer, e.g., a polyethylene, or a low melt temperature metal, as well as its method of use. The pressure relief device 10 is structured such that gas is gradually filtered and vented from the drum 30 over time in small amounts to maintain an acceptable and safe internal drum pressure. The term “fusible” as used herein shall mean a material that softens or melts at a temperature elevated above ambient. The term “drum” as used herein shall mean a storage container having a wall or walls 31, a lid 32 and a circular, internally threaded lid opening 33, the lid 32 being mounted to the wall or walls 31 of the drum 30 by mechanical interconnection, e.g., threading, clamping, bonding, crimping or any other suitable mechanism. Examples of such drums 30 are 30- and 55-gallon drums made of metal or rigid polymer. As illustrated representationally in FIG. 1, the drum 30 is shown as having a wall 31, a lid 32 and a lid opening 33 having internal threading 34, the lid 32 being secured to the drum wall 31 by mating external threading 35 on the lid 32 with internal threading 36 on the drum wall 31. The term “catastrophic failure” as used herein shall mean the sudden rupture of the drum wall 31 or the ejection of the drum lid 32 when the internal drum pressure increases to pressure X such that the strength of the material composing the wall 31 or the strength of the connection between the lid 32 and the wall 31 is insufficient to withstand the increased pressure. While the pressure relief device 10 is capable of releasing small amounts of gas to reduce the internal pressure of the drum 30, the venting capacity is too small to respond to emergency situations, such as when the drum 31 is exposed to fire and the temperature within the drum 30 rises rapidly, which in turn rapidly increase the internal pressure.

Pressure relief venting valves and pressure relief filtering and venting valves are known in the art, and the invention as described herein may incorporate various venting and/or filtering mechanisms or techniques that allow for the gradual release of small amounts of gases from the interior of the storage drum 30. The invention in effect provides a structure that transforms any of these pressure relief valves into a temperature responsive pressure relief valve that prevents catastrophic failure during rapid temperature/pressure elevation. Examples of pressure relief, filter vent valves are shown in U.S. Pat. Nos. 6,550,492, 5,353,949, 2,271,786, the disclosures of which are incorporated herein by reference.

As shown, a representative embodiment of the pressure relief device 10 comprises an exterior flange 11, typically polygonal in configuration to allow for easy rotation by hand or tool in order to mount or remove the device 10 form a drum 30. Extending beneath the flange 11 is a cylindrical body portion 12 of lesser width or diameter than the flange 11. An O-ring or similar gasket member 40 is mounted onto the body portion 12 and will be compressed against the drum lid 32 by the flange 11 when the device 10 is tightened onto the drum lid 32. The device 10 further comprises a tubular or cylindrical insertion or mating portion 13 having external threading 14. Internal passageways, bores or conduits, filter media, check valves and the like (not shown) facilitate and control the slow passage of gases through the device 10 for pressure relief under normal (i.e., ambient or near ambient) conditions.

The fusible collar or sleeve member 20 is a tubular member having external threading 21 and internal threading 22. The internal diameter of the sleeve member 20 and the pitch, size and other dimensional characteristics of the internal threading 22 is chosen such that the sleeve member 20 is tightly received onto and connects with the externally threaded mating portion 13 such that the two members 13/20 are joined in a manner that precludes passage of gases between the two members 13/20.

The external threading of the mating portion 13 and the internal threading 22 of the sleeve member 20 may be the same as or different than the external threading 21 of the sleeve member 20 with regard to number of threads, thickness of threads, pitch, etc. Most preferably, the direction of all threading should be the same, i.e., the threading should all be righthanded or all be lefthanded, such that tightening the mating portion 13 into sleeve member 20 also tightens the sleeve member 20 within the lid opening 33.

The external diameter of the collar member 20 and the pitch, size and other dimensional characteristics of the external threading 21 is chosen such that the sleeve member is tightly received within and connects with the internal threading 34 of the lid opening 33 in a manner that precludes passage of gases between the sleeve member 20 and the drum lid opening. With this structure, the drum lid opening 33 is completely sealed when the pressure relief device 10 with fusible sleeve member 20 is screwed into and mated to the drum 30.

The material of composition of the fusible sleeve member 20 may be a polymer (e.g., polyethylene) or metal which is sufficiently rigid under ambient or near ambient temperature to maintain the connection and seal with the drum 30, but which softens or melts at an elevated temperature, such as at a temperature of 800-1000 degrees C. as might be encountered in a fire. The thickness, length, number of threads, thickness of threads, pitch, etc., will also determine at what point the pressure relief device 10 is expelled from the drum lid 32.

Under rapidly elevating temperature conditions as might be encountered in a warehouse fire, the internal temperature of a drum 10 will rise, which in turn elevates the internal pressure within the drum 10. The rapid increase in internal pressure cannot be accounted for by the standard pressure relief mechanisms within the device 10, the size of the conduits and the filter media acting to limit the amount of gas than can be released. As the temperature of the fusible sleeve member 20 approaches or reaches the melting point of the fusible material, the sleeve member 20 softens or melts sufficiently such that the pressure buildup within the drum 30 will cause the device 10 to be expelled from the drum lid opening 33, thereby clearing the entire drum lid opening 33 for rapid relief of the internal pressure prior to catastrophic failure of the drum 30.

A drum 30 will have catastrophic failure when the pressure inside the drum 30 reaches a pressure X due to rapid external temperature increase, at which point the wall 31 will rupture or the lid 32 will be ejected from the drum 30. Upon determining the pressure X for a drum, the material of composition and/or structure of the fusible sleeve member 30 is chosen such that it softens or melts at the elevated temperature such that an internal drum pressure less than X will forcibly eject the device 10 from the drum lid opening 33, thereby allowing sufficient gas to escape the drum 30 to preclude catastrophic failure. Most preferably, the device 10 will be ejected at an internal drum pressure less than two-thirds of X. Thus, if catastrophic failure occurs at 15 psi, then the device 10 is ejected at 10 psi or less in elevated temperatures.

With this structure, the internal structure or mechanisms of a standard pressure relief filter vent device do not need to be altered to provide the safety pressure relief in emergency situations, as the internal structures and mechanisms are independent of the drum closure retention member, i.e., the fusible collar member 20. Utilization of the temperature responsive pressure relief assembly merely requires proper sizing of the drum closure insertion portion 13, the fusible collar member 20 and the drum opening 33, along with proper matching of the mating threads.

It is understood that equivalents and substitutions for certain elements set forth above may be obvious to those of skill in the art, and therefore the true scope and definition of the invention is to be as set forth in the following claims.

We claim:

1. A temperature responsive pressure relief filter vent device adapted to seal an internally threaded storage drum lid opening, said device structured to filter and gradually release gases from inside the storage drum, said device comprising a mating portion comprising external threading and a fusible sleeve member, said fusible sleeve member comprising internal threading and external threading, said fusible sleeve sized to receive said mating portion and to mount into the internally threaded drum lid opening.

2. The device of claim 1, wherein the storage drum has an internal drum pressure X at which catastrophic failure occurs, and wherein the material of composition of said fusible sleeve member is chosen such that in ambient temperature said device is retained within said drum lid opening at internal pressures up to internal drum pressure X, whereas in an elevated temperature said fusible sleeve member softens or melts such that said device is ejected from said drum lid opening at an internal drum pressure less than X.

3. The device of claim 2, wherein said device is ejected from said drum lid opening prior to the internal drum pressure reaching two-thirds of the internal drum pressure X.

4. The device of claim 1, wherein said fusible sleeve member is composed of a polymer.

5. The device of claim 1, wherein said external threads of said mating portion and said external threads of said fusible sleeve member are both righthanded or both lefthanded.

6. The device of claim 1, wherein the pitch of said external threads of said mating portion and said internal threads of said fusible sleeve member are different from the pitch of said external threads of said fusible sleeve member.

7. The device of claim 2, wherein said fusible sleeve member is composed of a polymer.

8. The device of claim 2, wherein said external threads of said mating portion and said external threads of said fusible sleeve member are both righthanded or both lefthanded.

9. The device of claim 2, wherein the pitch of said external threads of said mating portion and said internal threads of said fusible sleeve member are different from the pitch of said external threads of said fusible sleeve member.

10. The device of claim 3, wherein said fusible sleeve member is composed of a polymer.

11. The device of claim 3, wherein said external threads of said mating portion and said external threads of said fusible sleeve member are both righthanded or both lefthanded.

12. The device of claim 3, wherein the pitch of said external threads of said mating portion and said internal threads of said fusible sleeve member are different from the pitch of said external threads of said fusible sleeve member.

13. A method of preventing catastrophic failure in a storage drum, said drum having a threaded lid opening, comprising the steps of:
providing a temperature responsive pressure relief filter vent device adapted to seal an internally threaded storage drum lid opening, said device structured to filter and gradually release gases from inside the storage drum, said device comprising a mating portion comprising external threading and a fusible sleeve member, said fusible sleeve member comprising internal threading and external threading, said fusible sleeve sized to receive said mating portion and to mount into the internally threaded drum lid opening;
mounting said fusible sleeve member onto said mating portion; and
screwing said fusible sleeve member into the threaded lid opening of the drum.

14. The method of claim 13, further comprising the step of:
determining the internal drum pressure X at which catastrophic failure of the drum occurs; and
choosing the material of composition of said fusible sleeve member such that in ambient temperature said device is retained within the drum lid opening at internal pressures up to internal drum pressure X, whereas in an elevated temperature said fusible sleeve member softens or melts such that said device is ejected from said drum lid opening at an internal drum pressure less than X.

15. The method of claim 14, wherein said step of choosing the material of composition of said fusible sleeve member such that in ambient temperature said device is retained within the drum lid opening at internal pressures up to internal drum pressure X, whereas in an elevated temperature said fusible sleeve member softens or melts such that said device is ejected from said drum lid opening at an internal drum pressure less than X, comprises choosing the material composition such that said device is ejected at an internal pressure less than two-thirds of the internal pressure X.
